(19) United States
(12) Patent Application Publication
(10) Pub. No.: US 2015/0337847 A1
(43) Pub. Date: Nov. 26, 2015

(54) EXHAUST-GAS TURBOCHARGER

(71) Applicant: BorgWarner Inc., Auburn Hills, MI (US)

(72) Inventors: Silvio KOCH, Kirchheimbolanden (DE); Dieter ZEPPEI, Goennheim (DE)

(73) Assignee: BorgWarner Inc., Auburn Hills, MI (US)

(21) Appl. No.: 14/408,980

(22) PCT Filed: Jun. 20, 2013
(86) PCT No.: PCT/US2013/046755

§ 371 Date: Dec. 18, 2014

(30) Foreign Application Priority Data
Jun. 25, 2012 (DE) 102012012571.2

(51) Int. Cl. F04D 25/04; F04D 29/60; F02B 37/00

(52) U.S. Cl. CPC F04D 25/045; F02B 37/00; F04D 29/601

(57) ABSTRACT

An exhaust-gas turbocharger (1) having a bearing housing (2), a bearing cartridge (3) which is inserted into the bearing housing (2) and which has an outer ring (8) and an inner ring (9) which is mounted so as to be rotatable relative to the outer ring (8), a shaft (5) which is inserted into the inner ring (9) and which extends in an axial direction, a turbine wheel (6) which is arranged on the shaft (5), and a compressor wheel (7) which is arranged on the shaft (5), wherein the inner ring (9) protrudes beyond the outer ring (8) in the axial direction, and an oil centrifuge disk (12, 15) is arranged on the protruding part (11, 14) of the inner ring (9).

The invention relates to an exhaust-gas turbocharger according to the preamble of claim 1 and to a method for the assembly of the exhaust-gas turbocharger.

Already known exhaust-gas turbochargers normally have a shaft rotatably mounted in a bearing housing. A turbine wheel is mounted on one end of the shaft. A compressor wheel is mounted on the other end of the shaft. Both at the turbine side and also at the compressor side, the shaft emerges from the bearing house, and sealing is required between the shaft and the bearing housing or a bearing housing cover of the bearing housing. On the compressor side, for example, seal bushes are normally used for this purpose. Said seal bushes have so-called oil centrifuge disks. Said oil centrifuge disk prevents the seal, in particular the piston rings, from being impinged on directly by lubricating oil from the interior of the bearing housing.

It is an object of the present invention to provide an exhaust-gas turbocharger as per the preamble of claim 1 which, while being cost-effective to produce and assemble, can be operated reliably and with little maintenance. In particular, the sealing of the point at which the shaft emerges from the bearing housing should be configured so as to permit easy assembly. It is also an object of the present invention to specify a corresponding method for the assembly of the exhaust-gas turbocharger.

The object is achieved by the features of the independent claims. The dependent claims relate to preferred refinements of the invention.

According to the invention, use is not made of a separate seal bush with an oil centrifuge disk formed thereon. According to the present invention, the inner ring of a bearing cartridge is elongated in an axial direction to such an extent that it protrudes beyond the outer ring of the bearing cartridge. In this way, it is possible for the oil centrifuge ring to be arranged directly on the outer circumference of the inner ring of the bearing cartridge. It is provided according to the invention that the inner ring be elongated both at the turbine side and at the compressor side and that in each case one oil centrifuge disk be arranged on the protruding part of the inner ring.

It is also preferably provided that a seal for providing sealing between the inner ring and the bearing housing or a bearing housing cover of the bearing housing be formed directly on the protruding part of the inner ring. At the compressor side in particular, the seal is mounted directly on the protruding part of the inner ring.

As described above, it is likewise the case on the turbine side that the inner ring of the bearing cartridge is designed to be longer than the outer ring. In this way, it is also possible at the turbine side for the oil centrifuge disk to be formed on the inner ring. At the turbine side, the sealing with respect to the bearing housing preferably takes place between the shaft and the bearing housing. This means that, on this side, the seal is mounted directly on the shaft.

As a result of the elongation according to the invention of the inner ring of the bearing cartridge, and as a result of the fact that a separate seal bush is dispensed with, the parting joint between the inner ring and the seal bush is eliminated. In this way, the shaft assembly as a whole is made more rigid and more robust.

The oil centrifuge disk may be an integral constituent part of the inner ring. To avoid the need for a large amount of cutting outlay, it is alternatively provided that the oil centrifuge ring is pressed, welded, soldered or adhesively bonded onto the inner ring.

In its simplest embodiment, the bearing cartridge is a rolling bearing with an inner ring, with an outer ring and with rolling bodies situated in between.

The invention also encompasses a method for the assembly of an exhaust-gas turbocharger. The advantageous refinements proposed within the context of the exhaust-gas turbocharger according to the invention, and the subclaims, are correspondingly advantageously used with the method according to the invention.

In the method according to the invention, in the first instance an assembled unit composed of bearing cartridge and bearing housing cover is formed. For this purpose, the bearing housing cover is pushed onto the bearing cartridge. In the assembly process, the seal on the inner ring of the bearing cartridge serves for fixing the bearing housing cover with respect to the bearing cartridge. The assembled unit composed of bearing cartridge and bearing housing cover can thus be manufactured in a pre-assembly process and stored. In this way, the assembly time for the main assembly process of the exhaust-gas turbocharger as a whole is shortened.

Further details, advantages and features of the present invention become apparent from the following description of exemplary embodiments with reference to the drawing, in which:

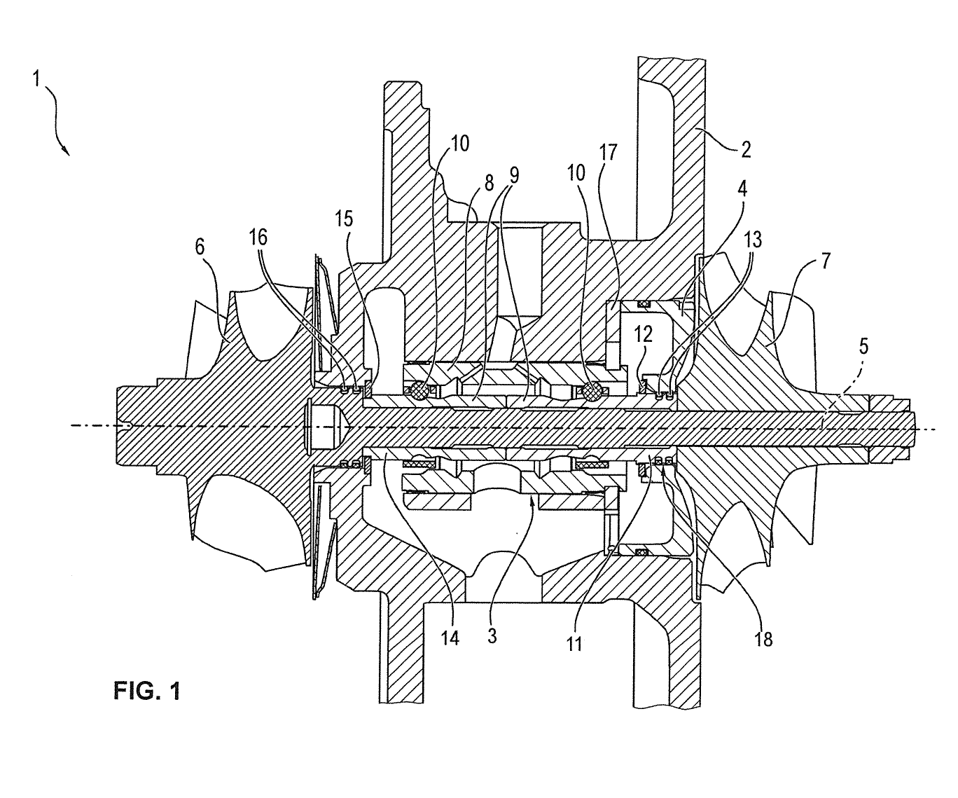

FIG. 1 shows an exhaust-gas turbocharger according to the invention as per a first exemplary embodiment,

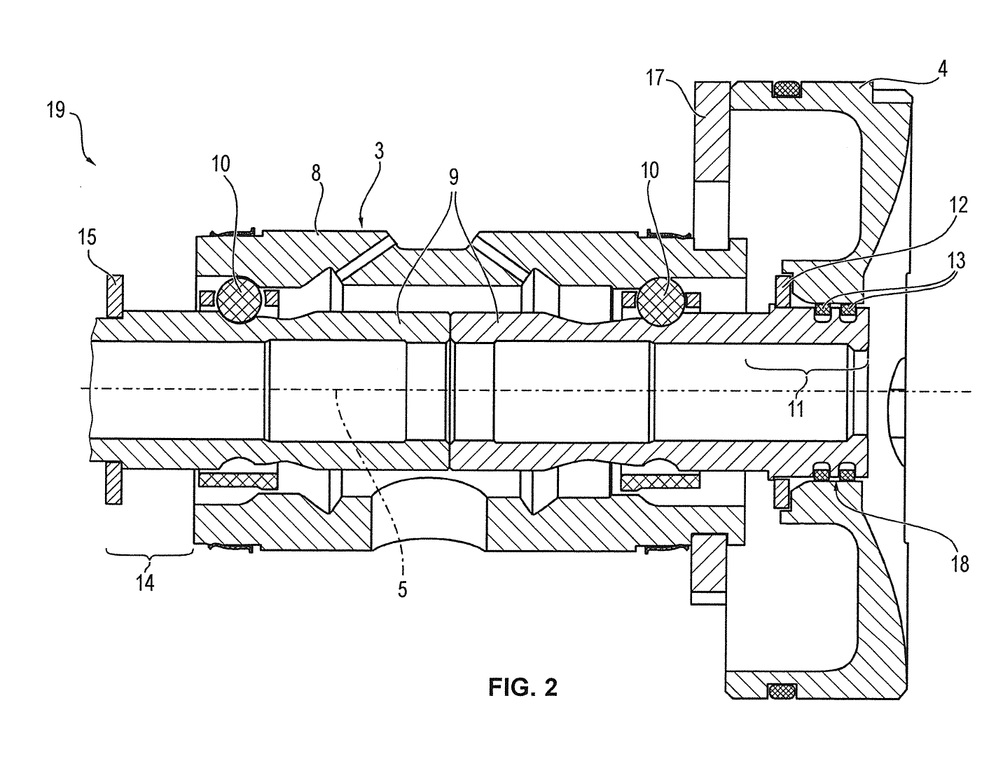

FIG. 2 shows an assembled unit of the exhaust-gas turbocharger according to the invention as per the first exemplary embodiment, and

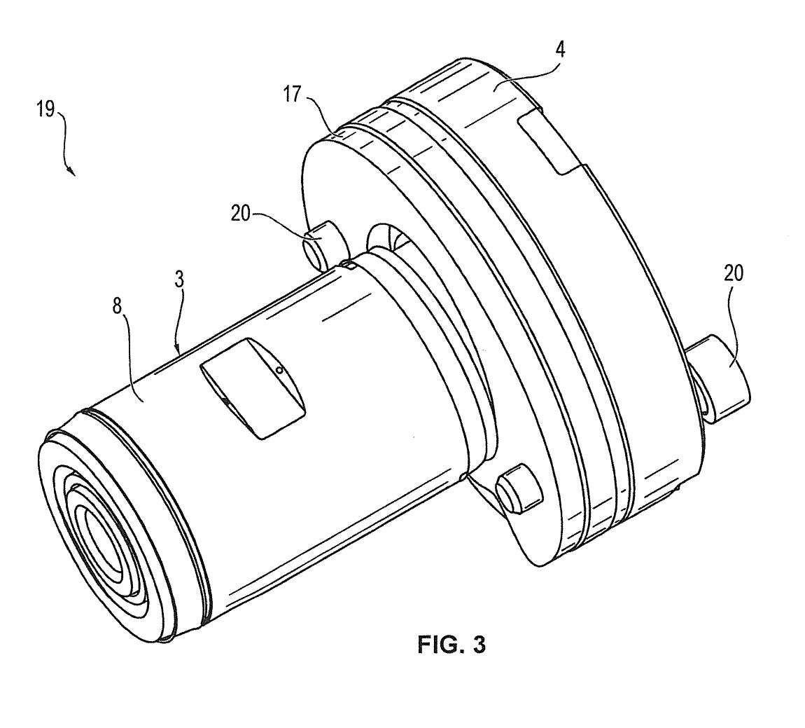

FIG. 3 shows an assembled unit of the exhaust-gas turbocharger according to the invention as per a second exemplary embodiment.

Two exemplary embodiments of the invention will be described below. Identical or functionally identical components are denoted by the same reference signs in all of the exemplary embodiments.

FIG. 1 shows a schematically simplified section through the exhaust-gas turbocharger 1. The exhaust-gas turbocharger 1 comprises a bearing housing 2 with a bearing cartridge 3 arranged therein. The bearing housing 2 is closed off by means of a bearing housing cover 4. A shaft 5, indicated merely by a dash-dotted line, is rotatably mounted in the bearing cartridge 3. A turbine wheel 6 is mounted on one end of the shaft 5. A compressor wheel 7 is mounted on the other end of the shaft 5.

During the operation of the exhaust-gas turbocharger 1, the turbine wheel 6 is impinged on by a flow of exhaust gas. In this way, the turbine wheel 6, the shaft 5 and the compressor wheel 7 are set in rotation. Charge air for an internal combustion engine is compressed by means of the compressor wheel 7.

The bearing cartridge 3 comprises an outer ring 8, a two-part inner ring 9 and a plurality of rolling bodies between the inner ring 9 and the outer ring 8. The outer ring 8 is fixedly connected to the bearing housing 2 by a fixing means 17. Here, the fixing means 17 may also be a constituent part of the bearing housing cover 4. The shaft 5 is rotationally conjointly connected to the inner ring 9.

At the compressor side, the inner ring 9 has a part 11 which protrudes beyond the outer ring 8. A seal 13 is formed on said part 11. Furthermore, an oil centrifuge ring 12 is mounted rotationally conjointly on the protruding part 11. The oil centrifuge ring 12 is situated between the seal 13 and the outer ring 8. The seal 13 provides sealing with respect to the bearing housing cover 4.

At the turbine side, the inner ring 9 has a further part 14, which protrudes beyond the outer ring 8. A further oil centrifuge ring 15 is mounted rotationally conjointly on the further protruding part 14. A further seal 16 is situated outside the further oil centrifuge ring 15. The further seal 16 is mounted directly on the shaft 5 and provides sealing between the shaft 5 and the bearing housing 2.

The seal 13 and the further seal 16 each have two piston rings which are inserted into grooves. The oil centrifuge rings 12, 15 are provided to protect said piston rings against direct impingement by lubricating oil.

FIG. 2 shows an assembled unit 19 of the first exemplary embodiment. Said assembled unit 19 comprises the bearing cartridge 3 with the two oil centrifuge disks 12, 15 and with the seal 13. Further constituent parts of the assembled unit 19 are the bearing housing cover 4 and the fixing means 17. A recess 18 is formed in the bearing housing cover 4. The bearing housing cover 4 is mounted, by way of said recess 18, on the protruding part 11, in particular on the seal 13. The seal 13 thus fixes the bearing housing cover 4 on the bearing cartridge 3, such that the assembled unit 19 is formed. In a further assembly step, the entire assembled unit 19 illustrated in FIG. 2 can be mounted in the bearing housing 2.

FIG. 3 shows the assembled unit 19 for the exhaust-gas turbocharger 1 as per the second exemplary embodiment. In the second exemplary embodiment, the inner ring has the protruding part 11 only at the compressor side. The oil centrifuge ring 12 and the seal 13 are arranged on said protruding part 11. In said exemplary embodiment, too, the bearing housing cover 4 is fixed on the bearing cartridge 3 by means of the seal 13, and can thus be pre-assembled. Furthermore, FIG. 3 shows a screw connection 20, in the form of a threaded bolt, for mounting the assembled unit 19 on the bearing housing 2.

In addition to the above written description of the invention, for additional disclosure of the latter, reference is hereby made explicitly to the diagrammatic illustration of the invention in FIGS. 1 to 3.

### LIST OF REFERENCE SIGNS

1 Exhaust-gas turbocharger
2 Bearing housing
3 Bearing cartridge
4 Bearing housing cover
5 Shaft
6 Turbine wheel
7 Compressor wheel
8 Outer ring
9 Inner ring
10 Rolling bodies
11 Protruding part
12 Oil centrifuge disk
13 Seal
14 Further protruding part
15 Further oil centrifuge disk
16 Further seal
17 Fixing means
18 Recess
19 Assembled unit
20 Screw connection

1. An exhaust-gas turbocharger (1) comprising:
a bearing housing (2),
a bearing cartridge (3) which is inserted into the bearing housing (2) and which has an outer ring (8) and an inner ring (9) which is mounted so as to be rotatable relative to the outer ring (8),
a shaft (5) which is inserted into the inner ring (9) and which extends in an axial direction,
a turbine wheel (6) which is arranged on the shaft (5), and
a compressor wheel (7) which is arranged on the shaft (5), wherein
the inner ring (9) protrudes beyond the outer ring (8) in the axial direction, and an oil centrifuge disk (12, 15) is arranged on the protruding part (11, 14) of the inner ring (9).

2. The exhaust-gas turbocharger as claimed in claim 1, wherein the oil centrifuge disk (12, 15) is an integral constituent part of the inner ring (9), or wherein the oil centrifuge disk (12, 15) is mounted rotationally conjointly on the inner ring (9).

3. The exhaust-gas turbocharger as claimed in claim 1, wherein a seal (13) for providing sealing with respect to the bearing housing (2) is inserted into the protruding part (11) of the inner ring (9).

4. The exhaust-gas turbocharger as claimed in claim 3, wherein the bearing housing (2) comprises a bearing housing cover (4), wherein the seal (13) is arranged so as to provide sealing with respect to the bearing housing cover (4).

5. The exhaust-gas turbocharger as claimed in either of claims 3 and claim 3, wherein the seal (13, 16) comprises at least one sealing ring and/or piston ring.

6. The exhaust-gas turbocharger as claimed in claim 1, wherein, on the side facing toward the compressor wheel (7), the oil centrifuge disk (12) is arranged on the protruding part (11) of the inner ring (9), and wherein, on the side facing toward the turbine wheel (6), a further oil centrifuge disk (15) is arranged on a further protruding part (14) of the inner ring (9).

7. The exhaust-gas turbocharger as claimed in claim 6, wherein, on the side facing toward the compressor wheel (7), the seal (13) is mounted on the protruding part (11) so as to provide sealing with respect to the bearing housing (2), and wherein, on the side facing toward the turbine wheel (6), a further seal (16) is mounted on the shaft (5) so as to provide sealing with respect to the bearing housing (2).

8. The exhaust-gas turbocharger as claimed in claim 6, wherein, on the side facing toward the turbine wheel (6), a further seal (16) is mounted on the protruding part (14) so as to provide sealing with respect to the bearing housing (2).

9. A method for the assembly of an exhaust-gas turbocharger (1), comprising the following steps in the stated sequence:
providing a bearing cartridge (3) having an outer ring (8) and an inner ring (9) which is mounted so as to be rotatable relative to the outer ring (8), wherein the inner ring (9) protrudes beyond the outer ring (8) in an axial direction, and an oil centrifuge disk (12) and a seal (13) are arranged on the protruding part (11) of the inner ring (9),
mounting a bearing housing cover (4) onto the bearing cartridge (3) such that the bearing housing cover (4) and the bearing cartridge (3) are fixed to one another by means of the seal (13), and
mounting the assembled unit (19) composed of bearing cartridge (3) and bearing housing cover (4) in a bearing housing (2) of the exhaust-gas turbocharger (1).

10. The exhaust-gas turbocharger as claimed in claim 6, wherein, on the side facing toward the compressor wheel (7), the seal (13) is mounted on the protruding part (11) so as to provide sealing with respect to the bearing housing cover (4), and wherein, on the side facing toward the turbine wheel (6), a further seal (16) is mounted on the shaft (5) so as to provide sealing with respect to the bearing housing (2).
